(19) United States
(12) Patent Application Publication
(10) Pub. No.: US 2012/0274257 A1
(43) Pub. Date: Nov. 1, 2012

(54) Motor Control System

(75) Inventor: David Huw Taylor, Christchurch (GB)

(73) Assignee: PG DRIVES TECHNOLOGY LIMITED, DORSET (GB)

(21) Appl. No.: 13/381,968

(22) PCT Filed: Jul. 1, 2010
(86) PCT No.: PCT/GB10/01273

§ 371 Date: May 14, 2012

(30) Foreign Application Priority Data
Jul. 2, 2009 (GB) 0911502.3

(51) Int. Cl. H02P 29/02

(52) U.S. Cl. 318/473

(57) ABSTRACT

A motor control system has a sensor for measuring an operational parameter of a motor and includes means for converting the measured operational parameter into an electrical resistance value. The operational parameter measured by the sensor is the rotational speed of the motor which is converted into a back electro-motive force value. The back electro-motive force value is then used, along with a measured input voltage value and measured motor current value to calculate the electrical resistance as value. The electrical resistance value is then compared to a threshold value and in the case that the threshold value is reached, the current flow in to the motor is adjusted.

This invention relates generally to a motor control system.

Motor control devices are currently used to prevent an overload condition in a motor or its circuitry. Traditionally this has been achieved by monitoring the current of a motor. Alternative techniques place a resistor in series with the motor. The voltage across the resistor is monitored and the current flow through the resistor is determined. Such devices are required since excess current can increase the amount of heat that a motor is generating, which can lead to damage of the motor coil. By monitoring the current and adjusting the current flow when it exceeds a permitted current flow value, damage to a motor can be prevented.

For example in US 2008/0054833, a voltage command with value V* is provided by the user and passed into the speed controller, along with the measured voltage V of the motor. The measured voltage V is calculated from the measured motor speed which is read by an encoder. A current command out of the speed controller varies depending on the difference between the command voltage and the measured motor voltage. The command current is then received by a temperature estimation device that uses pre-programmed data curves to determine the estimated temperature for a given command current. The temperature estimate is compared to a threshold value of temperature and this information is sent to a Current Controller. In the case that the command current would cause the motor to overheat, the current supplied to the motor by the Current Controller is reduced. This prevents the excess estimated temperature value from being reached and prohibits damage to the motor.

A disadvantage of the system disclosed in US 2008/0054833 is that when the actual voltage V is less than the voltage command value V*, the measured physical properties of the motor are not used in determining what adjustment in current is needed to reduce the temperature of the motor.

Another document, WO 2008/016744, uses a Hall effect switch to determine the speed of the motor. As the pole of the magnet passes through the switch electrical pulses are produced and these pulses are compared to a threshold value. This is desirable since motor speed in a permanent magnetic DC motor is inversely proportional to motor current. In the case that the pulse width is greater than the threshold value (i.e. the motor speed is less than the threshold speed) the processor averages the next 12 pulses. If the average motor speed is found to be less than the threshold speed after this averaging process then an overload condition is confirmed and the motor is turned off. The document also considers input voltage and temperature when determining the threshold.

A disadvantage of the system disclosed in WO 2008/016744 is that on detection of an overload condition the circuitry of WO 2008/016744 is arranged to switch the motor off completely. Only when the overload condition is resolved will the motor be put back into operation. Therefore, there is no self-regulation of the current into the motor and instead there are only two distinct operational states i.e. current permitted to flow and current prohibited to flow.

It is, therefore, an object of the present invention to provide an improved motor control system which alleviates the above mentioned disadvantages.

In accordance with a first aspect of the present invention, there is provided a motor control system comprising:

a sensor for measuring an operational parameter of a motor;
means for converting the measured operational parameter into an electrical resistance value; comparing the electrical resistance value to a threshold value; and, in the case that the threshold value is reached, adjusting the current flow into the motor.

In a preferred embodiment, the sensor measures the motor speed and forwards the measured motor speed to a motor controller, the motor controller being arranged to permit conversion of the measured motor speed in to a motor back electro-motive force value;

and further permitting the converted motor back electro-motive force value to be used, along with a measured input voltage value and a measured motor current value, to calculate the electrical resistance value of the motor;
further wherein the motor controller is configured such that if the calculated electrical resistance value reaches a first threshold value, the current in to the motor is limited.

Preferably, the sensor is capable of detecting the rotational speed of the motor.

Further, it is preferred that, the speed sensor is an optical encoder or a magnetic encoder.

Beneficially, the measured rotational speed is received by software within a Motor controller.

Desirably, the motor controller determines the motor back electro-motive force (emf) by dividing the motor speed by the motor speed constant.

Beneficially, the determined value of the motor back emf E is substituted into R=(V−E)/I, along with the measured input voltage V and motor current I so as to calculate the electrical resistance R of the motor.

Preferably, the motor controller is configured such that when the electrical resistance is seen to fall below the first or a second threshold value, the current flow is increased.

Beneficially the first and/or second threshold value is pre-programmed.

Beneficially, the first and/or second threshold value is dependent on the ambient temperature and system input voltage.

Further, there is provided a method of self-regulating the current into a motor the method comprising:

measuring an operational parameter of a motor;
converting the measured operational parameter into an electrical resistance value;
comparing the electrical resistance value to a threshold value; and, in the case that the threshold is reached, adjusting the current flow into the motor.

Preferably the method further comprises the motor speed being measured; converting the measured motor speed into a motor back electro-motive force value;

calculating the electrical resistance of the motor from the motor back electro-motive force value, a measured input voltage value and a measured motor current value;
and, in the case where the electrical resistance value reaches a first threshold value when comparing the electrical resistance to a threshold value, the current in to the motor being limited.

These and other aspects of the invention will be apparent from, and elucidated with reference to, the embodiment as described herein.

An embodiment of the present invention will now be described, by way of example only and with reference to the accompanying drawings, in which:

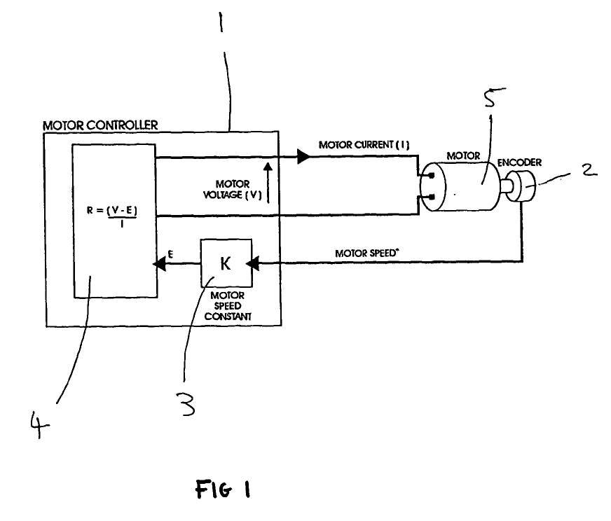

FIG. 1 is a block diagram showing a motor control system according to the invention.

In FIG. 1 there is shown a motor control system, for self regulating the current in to a motor, comprising a motor controller 1, a motor 5 and a speed sensor 2.

In operation, electrical power is input into the motor and this electrical power P_{elec} is converted into mechanical power P_{mech}. However, some of the power is lost as heat Pₕₑₐₜ, due to ohmic heating of the motor coils. This power relationship is described by:

P_{elec}=Pₕₑₐₜ+P_{mech}

In terms of electrical and mechanical quantities this becomes V=I²R+τω, where V is the voltage across the motor terminals, I is the current through the motor, τ is the torque produced by the motor and ω is the angular velocity.

The wire coils have both resistance R and inductance L. Therefore, the motor may be defined by the basic motor formula:

V=IR+L dI/dt+E,

where E is called the back emf which is proportional to the speed of the motor and is given by E=speed/k, where k, the speed constant depends on the motor design. Typically, but not exclusively, the rotational speed is measured in revolutions per minute (rpm).

When considering the steady state operation of a motor, i.e. when the current is constant, the term LdI/dt becomes zero and the basic motor formula takes the following form:

V=IR+E.

The controller has an accurate knowledge of V and I and the back emf can be accurately calculated with precision measurements of rotational speed of the motor and accurate knowledge of the speed constant k. Therefore, by rearranging the basic motor formula in the steady state condition for R and substituting for V, I and E, the Resistance of the motor can be accurately determined.

Since the electrical resistance of a conductor is dependent upon collisions of the electrons within the conductor, a fractional change in resistance, ΔR, is proportional to a change in temperature, ΔT. In a simplified form, the resistance of a material, for example the motor coil, shows a linear relationship to the temperature of the motor coil, within a certain temperature range T₁<T<T₂.

The linear R-T function is given as:

$$T = {T}_{ref} + \frac{( R \text{/} {R}_{ref} ) - 1}{α} ,$$

where α is the average temperature coefficient of resistance in the (T₁,T₂) temperature range. T-T_{ref} and R-R_{ref} give ΔT and ΔR respectively and must also lie within the (T₁,T₂) temperature range.

In operation, it is possible for the coil in the motor to burn out due to the motor overheating. Therefore, in order to prevent this type of event occurring, the temperature of the motor coil can be monitored and adjusted by measuring the electrical resistance of the coil and controlling the current flow in to the motor. It is preferred for the temperature of the motor to be merely regulated without determining the precise value of T.

In a first embodiment the speed sensor is an optical encoder 2 arranged to measure the rotational speed of a permanent magnet motor 5 and this measured value of rotational speed is received by a motor controller 1. The motor controller 1 comprises a back emf converter 3 which receives the measured value of rotational speed and is programmed to calculate the back emf of the motor by dividing the value of the motor rotational speed by the value of the motor speed constant that is stored in the motor controller 1. The motor speed constant is predetermined and dependent on the motor design. The motor controller 1 also comprises circuits, for accurately measuring the average voltage applied to the motor and the current flowing through the motor (not shown), and a resistance calculator component 4. The calculated value of back emf is received by the resistance calculator component 4 and is used, along with the determined values of motor voltage and motor current, to calculate the electrical resistance of the motor using software that implements the basic motor formula in the steady state condition.

The resistance is proportional to the temperature of the motor, therefore a programmed temperature threshold may be set which can be translated into a resistance threshold that is stored in the motor controller.

In operation, the calculated value of the motor resistance is compared to a first programmed resistance threshold value. In the instance that the resistance reaches the first threshold, the motor controller will reduce the flow of current to the motor. This has the effect of reducing the amount of heat generated by the motor. The comparison of the calculated value of the electrical resistance with the first threshold value continues until the calculated resistance value falls below the first threshold. Alternatively, the calculation of the electrical resistance can be continued until the calculated electrical resistance falls below a second programmed resistance threshold that is different to the first programmed threshold. When the calculated value of the resistance falls below the first electrical resistance threshold, or alternatively the second electrical resistance threshold, the current flow may be increased until the full current can be allowed to flow.

Therefore, the motor control device is arranged to self-regulate the temperature of the motor by adjusting the current flow to the motor in dependence upon the calculated value of the motor resistance.

In the embodiment presented here, the first threshold and the second threshold are pre-programmed.

However, in further embodiments, the first threshold value and the second threshold value may be adjusted according to the ambient temperature of the motor or the motor supply voltage and may be determined in real time. This may be performed manually or may be automated. Sensors for determining the real time quantities of the motor ambient temperature and motor supply voltage may be integrated within the motor or its circuitry (not shown), and temperature and voltage readings may be received by the motor controller where the data may be stored in a memory device or used to alter the threshold value instantaneously.

In a further embodiment of the invention, it is possible to accurately determine the value of T by inserting measured quantities into the simplified resistance-temperature equation, or by curve-fitting with pre-determined R-T curves or via other iteration techniques that may utilise stored R-T data.

A user interface may be provided, for instance a key pad or dial, to select the desired temperature threshold. A display interface may also be provided for displaying the measured temperature of the motor or, the desired motor temperature, or other physical, mechanical or electrical operational parameter of interest. The control system may also comprise memory space for recording data. This could be useful in determining trends or anomalies in the data, whereby the latter could potentially predict severe motor malfunctions before they occur.

The encoder described here is of an optical form, but other types of encoder, for example magneto-resistant, magnetic with hall sensors or a tachometer, may also be suitable for this application. Other rotation detection means to measure the electrical potential difference between the shaft and the ground in order to generate a rotation information signal in response to the changes in the electrical potential difference as the shaft rotates may be implemented. Preferably, the encoder has a frequency output which is proportional to the speed of the motor.

The encoder provides a set number of pulses per shaft rotation, which may not be evenly spaced, therefore the speed measurement is carried out by measuring the number of pulses over a timed period (rather than measuring the time between pulses). This method is beneficial since frequency averaging helps to reduce the effect of spurious pulses and noise. For best accuracy, 50 pulses per time period are used. In an alternative embodiment, the averaging process may be triggered after the measured resistance value has reached the first threshold value and before the current flow in to the motor is adjusted.

It is clear that although the motor controller 1 houses several components, for example the resistance calculator and the emf converter, each of these components may be separated from the motor controller as independent elements of the system.

In a further embodiment the electrical resistance can be calculated by using the measured torque of the motor in combination with the motors angular velocity.

R=(V−(τ/I)ω))/I

The torque may also be represented as KₘI where Kₘ is the motor constant, or torque constant, k_{M}, which is the inverse of the speed constant. Therefore, in a further embodiment it is possible to calculate the resistance using the following—

R=(V−Kₘω))/I

Advantages include that an accurate determination of the motor resistance is achieved and the physical relationship between resistance and temperature permits the motor temperature to be regulated in order to prevent an overload condition, therefore providing an improvement in safety. Further, the system offers environmental and financial benefits since it minimises the amount of power lost through heat.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. A motor control system comprising:
a sensor for measuring an operational parameter of a motor;
a converter for converting the measured operational parameter into an electrical resistance value; and
a comparer for comparing the electrical resistance value to a first threshold value;
wherein, in the case that the first threshold value is reached, adjusting the current flow in to the motor.

2. A motor control system according to claim 1, wherein an operational parameter comprises the speed of the motor.

3. A motor control system according to claim 2, wherein the measured motor speed is converted in to a motor back electro-motive force value.

4. A motor control system according to claim 3, wherein the converted motor hack electro-motive force value can be used, along with a measured input voltage value and a measured motor current value, to calculate the electrical resistance value of the motor.

5. A motor control system according to claim 1, to wherein in the case that the electrical resistance value reaches the first threshold value, the current flow in to the motor is limited.

6. A motor control system according to claim 1, wherein an operational parameter comprises the rotational speed of the motor.

7. A motor control system according to claim 1, wherein the sensor comprises one of an optical encoder or a magnetic encoder.

8. A motor control system according to claim 1 further comprising a motor controller having software;
wherein the sensor measures the rotational speed of the motor; and
wherein the measured rotational speed is provided to the software of the motor controller.

9. A motor control system according to claim 1, wherein an operational parameter comprises the rotational speed of the motor;
wherein the measured rotational motor speed is converted in to a motor hack electro motive force value; and
wherein the electro-motive force value is determined by dividing the rotational motor speed by a motor speed constant that is redetermined and dependent on the motor design.

10. A motor control system according to claim 3 further comprising:
measuring the input voltage;
measuring the motor current; and
calculating the electrical resistance of the motor with the following equation:
E=(V−E)/I,
wherein:
V is the input voltage;
E is the motor back electro-motive force value;
I is the motor current; and
R is the electrical resistance of the motor.

11. A motor control system according to claim 1, wherein in the case the electrical resistance value falls below either the first or a second threshold value, the current flow is increased,

12. A motor control system according to claim 11 wherein the first and/or second threshold value is pre-programmed.

13. A motor control system according to claim 11, wherein the first and/or second threshold value is dependent on one or both of the ambient temperature of the system and a system input voltage.

14. A method of self-regulating the current in to a motor comprising:
measuring an operational parameter of a motor;
converting the measured operational parameter into an electrical resistance, value;
comparing the electrical resistance value to a threshold value; and
adjusting the current flow in to the motor if the first threshold value is reached.

15. A method according to claim 14, wherein the measured operational parameter is the motor speed of the motor.

16. A method according to claim 15, wherein the measured motor speed is converted into a motor back electro-motive force value.

17. A method according to claim 16 further comprising:
measuring the input voltage;
measuring the motor current; and
calculating the electrical resistance value of the motor by using the motor back electro-motive farce value, the measured input voltage value and the measured motor current value.

18. (canceled)

19. A method of self-regulating the current in to a motor the method comprising:
measuring the motor speed of a motor;
converting the measured motor speed into a motor electro-motive force value;
calculating the electrical resistance value of the motor from the converted electro-motive force value, a measured voltage input voltage value and a measured motor current value;
comparing the electrical resistance value to a threshold value, and
limiting the current flow into the motor if the threshold value is reached.

20. A motor control system comprising:
a sensor for measuring the motor speed of a motor;
converting means for converting the measured motor speed into a motor back electro-motive force value;
a calculator for calculating the electrical resistance value of the motor using the converted motor back electro-motive force value, along with a measured input voltage value and a measured motor current value; and
a comparer for comparing the electrical resistance value, to a threshold value;
wherein in the case that the threshold value is reached, limiting the current flow in to the motor.
